(19) United States
(12) Patent Application Publication
(10) Pub. No.: US 2016/0363545 A1
(43) Pub. Date: Dec. 15, 2016

(54) METHOD FOR MEASURING THE EFFECTIVE ATOMIC NUMBER OF A MATERIAL

(71) Applicant: Commissariat A L'Energie Atomique Et Aux Energies Alternatives, Paris (FR)

(72) Inventors: Alexia GORECKI, Grenoble (FR); Jean RINKEL, Bures-sur-Yvette (FR)

(73) Assignee: Commissariat A L'Energie Atomique Et Aux Energies Alternatives, Paris (FR)

(21) Appl. No.: 15/106,569

(22) PCT Filed: Dec. 9, 2014
(86) PCT No.: PCT/EP2014/076960

§ 371 Date: Jun. 20, 2016

(30) Foreign Application Priority Data
Dec. 20, 2013 (FR) 13 63174

(51) Int. Cl. G01N 23/087

(52) U.S. Cl. CPC G01N 23/087

(57) ABSTRACT

A method for estimating the effective atomic number of a material from a transmission spectrum of said material in which a likelihood function of the effective atomic number and the thickness of the material is calculated on the basis of the transmission spectrum as well as calibration spectra obtained in a previous calibration phase for a plurality of samples of calibration materials of known effective atomic numbers and known thicknesses. The effective atomic number of the material is then estimated on the basis of values of the likelihood function.

### TECHNICAL FIELD

This invention relates to the field of physically characterising a material and more particularly that of measuring its effective atomic number by X or gamma spectroscopy. It has applications in particular in the field of medical imaging and non-destructive testing.

### PRIOR ART

The effective atomic number is part of the parameters that can characterise a material. Recall that the atomic number of a simple body is defined as the number of protons present in the nucleus of an atom of this body. On the other hand, when a chemical compound is being considered, the notion of effective atomic number must be used. The latter is defined as the atomic number of a simple body that would lead to the same transmission spectrum in a given band of energy. Generally, the effective atomic number of a chemical compound is obtained by means of a combination of the atomic numbers of the atomic numbers of the simple bodies that constitute the compound, with each atomic number being assigned a weighting coefficient that depends on the mass or atomic fraction of the simple body in the compound. As such, in practice, the effective atomic number Z_{eff} of a compound of N simple bodies, satisfies

$${Z}_{eff} = {( {\sum }_{i = 1}^{N} {{η}_{i} ( {Z}_{eff}^{i} )}^{p} )}^{1 / p}$$

where Z_{eff}ⁱ is the atomic number of the simple body i=1, . . . , N and p is a constant linked to the photoelectric effect (p=4,62).

The measurement of the effective atomic number of a material is conventionally carried out using X-ray or gamma-ray spectrometry. Direct conversion spectrometric sensors are generally used for this, i.e. sensors wherein the X or gamma photons that have interacted with the material to be analysed are absorbed by a semiconductor element (CdTe for example). More precisely, an incident photon on this element creates therein a cloud of electronic charges (typically 10,000 electrons for an X photon of 60 keV). These charges are then collected by collection electrodes arranged on this element. The charges generated by an incident photon and collected as such form a pulse form transient electric signal. If the collection of the charges is complete, the integral of the pulse measured is proportional to the energy of the incident photon. The histogram of energies measured as such provides a spectrum of the radiation that has interacted with the material. This spectrum provides information on the density as well as the nature of the material, and makes it possible to estimate the effective atomic number of it.

A method for measuring the effective atomic number of a material is described in U.S. Pat. No. 6,069,936. It consists in irradiating the material with a first radiation that has a first energy spectrum in order to obtain a first attenuation profile, then with second radiation that has a second energy spectrum in order to obtain a second attenuation profile, and to determine the effective atomic number of the material from a ratio between the first and second profiles obtained as such. The first energy spectrum can correspond to a high range of energy and the second energy spectrum can correspond to a lower energy range. The effective atomic number is determined from a table wherein are stored during a collection phase profile reports for materials with known atomic numbers.

This method does not however make it possible to determine the atomic number of a material with a satisfactory degree of precision and reliability.

The object of this invention is consequently to propose a method for measuring the effective atomic number of a material that is both reliable and precise.

### DISCLOSURE OF THE INVENTION

The invention relates to a method for measuring the effective atomic number of a material for a predetermined X or gamma spectral band, wherein:

a transmission spectrum (S^{a}=(n₁^{a}, n₂^{a}, . . . , n_{N}^{a})^{T}) of a sample of said material is measured in a plurality (N) of energy channels of said spectral band;

a likelihood function of the effective atomic number and of the thickness of the sample of said material is calculated from the transmission spectrum measured as such and from a plurality of transmission spectra (S^{c}(Zₚ^{c},e_{q}^{c})), referred to as calibration spectra, obtained for a plurality of samples of calibration materials having known effective atomic numbers and known thicknesses, with said likelihood function being calculated for at least said known effective atomic numbers (Zₚ^{c}) and the known thicknesses (e_{q}^{c}) in order to provide a plurality of values of said likelihood function,

the effective atomic number (\hat{Z}) of said material is estimated on the basis of values of the likelihood function obtained as such.

Advantageously, the calibration spectra are interpolated in order to obtain an interpolated calibration spectrum for each effective atomic number belonging to a first interval ([Zₘᵢₙ,Zₘₐₓ]), and for each effective atomic number belonging to this interval and each given thickness, a value of said likelihood function is calculated.

In the same way, the calibration spectra can advantageously be interpolated in order to obtain an interpolated calibration spectrum for each effective atomic number belonging to a second interval ([eₘᵢₙ, eₘₐₓ]) and to calculate for each thickness belonging to this interval and each given effective atomic number, a value of said likelihood function.

According to a first embodiment, for each calibration material (p) of known effective atomic number (Zₚ^{c}), the maximum value (Vₚ) of the likelihood function is determined from the values of the likelihood function (V(Zₚ^{c},e_{q}^{c}) q=1, . . . , Q) obtained for the known thicknesses of the samples of this material, said maximum value then being associated with the material.

According to a second embodiment, for each calibration material (p) of known effective atomic number (Zₚ^{c}), an interpolation is carried out between the calibration spectra relative to known thicknesses in order to determine an interpolated calibration spectrum for each thickness of a given thickness interval ([eₘᵢₙ, eₘₐₓ]), with the likelihood function being evaluated over this thickness interval from the interpolated calibration spectrum, and the maximum value of the likelihood function is determined over said thickness interval, said maximum value being associated with the material.

According to the first embodiment, the effective atomic number (\hat{Z}) of the material can be estimated as the average of the known effective atomic numbers of the calibration materials, weighted by the maximum values of the likelihood function that are respectively associated to them.

According to the second embodiment, the effective atomic number (\hat{Z}) of the material can be estimated as the average of the effective atomic numbers belonging to a first interval ([Zₘᵢₙ,Zₘₐₓ]), weighted by the maximum values of the likelihood function that are respectively associated to them.

According to the second embodiment, for each calibration material (p) of known effective atomic number (Zₚ^{c}), an interpolation can alternatively be carried out between the calibration spectra relative to known thicknesses in order to determine an interpolated calibration spectrum for each thickness of a given thickness interval ([eₘᵢₙ,eₘₐₓ]), with the likelihood function being evaluated over this thickness interval from the interpolated calibration spectrum, then integrated over this thickness interval in order to give a marginal likelihood function value associated with this calibration material.

In this case, the effective atomic number (\hat{Z}) of the material can be estimated as the average of the known effective atomic numbers of the calibration materials, weighted by the values of the marginal likelihood function respectively associated with these calibration materials.

In any case, the values of the likelihood function can be determined for each pair (Zₚ^{c},e_{q}^{c}) of effective atomic number and of thickness by:

$$V ( {Z}_{p}^{c} , {e}_{q}^{c} ) = \frac{1}{{\prod }_{i = 1}^{N} {n}_{i}^{c}} exp [ - {\sum }_{i = 1}^{N} \frac{{( {μ}_{i} {n}_{i}^{a} - {n}_{i}^{c} )}^{2}}{2 {( {n}_{i}^{c} )}^{2}} ]$$

where the nᵢ^{a}, i=1, . . . , N are the values of the transmission spectrum of the material in the various channels, nᵢ^{c}, i=1, . . . , N are the values of the transmission spectrum of the calibration material in these same channels and μᵢ is the ratio between the number of photons received in the channel i in the absence of material during the calibration (n_{0,i}^{e}) and the number of photons received in the absence of material during the measuring (n_{0,i}^{a}) in the same channel.

Advantageously, according to the second embodiment, for each pair (Z,e) of effective atomic number belonging to a first interval and of thickness belonging to a second interval, the likelihood function V(Z,e) is calculated using:

$$ln ( V ( Z , e ) ) = - μ {\overline{n}}^{c} + {\sum }_{i = 1}^{N} {n}_{i}^{a} ln ( μ {n}_{i}^{c} )$$

where the nᵢ^{a}, i=1, . . . , N are the values of the transmission spectrum of the material in the various channels, nᵢ^{c}, i=1, . . . , N are the values of the interpolated transmission spectrum in these same channels, μ is the ratio between the total number of photons received in all of the channels and in the absence of material during the measuring and the total number of photons received in the same set of channels and in the absence of material during the calibration, and n̅_{c} is the total number of photons received in the same set of channels in the presence of the calibration material, during the calibration.

The atomic number of the material can then be estimated as being the one (\hat{Z}_{ML}) that maximises the likelihood function V(Z,e) on the range constituted by the Cartesian product of the first interval and the second interval.

Alternatively, the marginal density (p(Z)) of the likelihood function over said first interval can be determined, by integrating the density of the likelihood function over the second interval.

The effective atomic number of the material can then be estimated as being the one (\hat{Z}_{marg}) that maximises the marginal density over said first interval. Alternatively, the effective atomic number of the material can be estimated as being the average of the effective number (Z_{moy}) weighted by the marginal density of the likelihood function over said first interval.

Advantageously, according to the second embodiment, for a thickness e between a first known thickness e_{q}^{c} and a second known thickness e_{q+1}^{c} where e_{q}^{c}<e<e_{q-1}^{c}, an interpolated calibration spectrum S^{c}(Z^{c},e) is obtained for the effective atomic number Z^{c} and the thickness e from the calibration spectra S^{c}(Z^{c},e_{q}^{c}) and S^{c}(Z^{c},e_{q+1}^{c}) respectively obtained for the same effective atomic number and the respective thicknesses e_{q}^{c} and e_{q+1}^{c}, by means of:

$$ln [ {n}_{i}^{c} ( {Z}^{c} , e ) ] = ( \frac{{e}_{q + 1}^{c} - e}{{e}_{q + 1}^{c} - {e}_{q}^{c}} ) ln [ {n}_{i}^{c} ( {Z}^{c} , {e}_{q}^{c} ) ] + ( \frac{e - {e}_{q}^{c}}{{e}_{q + 1}^{c} - {e}_{q}^{c}} ) ln [ {n}_{i}^{c} ( {Z}^{c} , {e}_{q + 1}^{c} ) ]$$

where nᵤ^{c}(Z^{c},e), nᵢ^{c}(Z^{c},e_{q}^{c}) and nᵢ^{c}(Z^{c},e_{q+1}^{c}) are the respective values of the spectra S^{c}(Z^{c},e), S^{c}(Z^{c},e_{q}^{c}) and S^{c}(Z^{c}, e_{q+1}^{c}) in the channel i of the spectral band.

Similarly, for an effective atomic number Z between a first known effective atomic number Zₚ^{c} and a second known effective atomic number Zₚ₊₁^{c} where Zₚ^{c}<Z<Zₚ₊₁^{c}, an interpolated calibration spectrum S^{c}(Z,e^{c}) is advantageously obtained for the effective atomic number Z and the thickness e^{c} from the calibration spectra S^{c}(Zₚ^{c},e^{c}) and S^{c}(Zₚ₊₁^{c},e^{c}) respectively obtained for the same thickness e^{c} and the respective atomic numbers Zₚ^{c} and Zₚ₊₁^{c}, by means of:

$$ln [ {n}_{i}^{c} ( Z , {e}^{c} ) ] = ( 1 - {γ}_{p}^{1} \frac{ρ}{{ρ}_{p}} - {γ}_{p}^{2} \frac{ρ}{{ρ}_{p + 1}} ) ln [ {n}_{0 , i}^{c} ] + ( {γ}_{p}^{1} \frac{ρ}{{ρ}_{p}} ) ln [ {n}_{i}^{c} ( {Z}_{p}^{c} , {e}^{c} ) ] + ( {γ}_{p}^{2} \frac{ρ}{{ρ}_{p + 1}} ) ln [ {n}_{i}^{c} ( {Z}_{p + 1}^{c} , {e}^{c} ) ]$$

where nᵢ^{c}(Z,e^{c}), nᵢ^{c}(Zₚ^{c},e^{c}), nᵢ^{c}(Zₚ₊₁^{c},e^{c}) are the respective values of the spectra S^{c}(Z,e^{c}), S^{c}(Zₚ^{c},e^{c}) and S^{c}(Zₚ₊₁^{c},e^{c}) in the channel i of the spectral band, n_{0,t}^{c} is the score of the full flow spectrum in the channel i,

$${γ}_{p}^{1} = \frac{{( {Z}_{p + 1}^{c} )}^{r} - {Z}^{r}}{{( {Z}_{p + 1}^{c} )}^{r} - {( {Z}_{p}^{c} )}^{r}} , \\ {γ}_{p}^{2} = \frac{{Z}^{r} - {( {Z}_{p}^{c} )}^{r}}{{( {Z}_{p + 1}^{c} )}^{r} - {( {Z}_{p}^{c} )}^{r}} ,$$

r is a predetermined real constant, ρₚ, ρₚ₊₁, are respectively the densities of the materials p and p+1, and where ρ is the density of the material of atomic number Z obtained by interpolation between the densities ρₚ and ρₚ₊₁.

### BRIEF DESCRIPTION OF THE DRAWINGS

Other characteristics and advantages of the invention shall appear when reading the preferred embodiments of the invention, in reference to the enclosed figures among which:

FIG. 1 diagrammatically shows a flowchart of a method for measuring according to a first embodiment of the invention;

FIG. 2 diagrammatically shows a flowchart of a method for measuring according to a second embodiment of the invention;

FIG. 3A shows the likelihood function of the effective atomic number and of the thickness for a sample, FIG. 3B shows the corresponding marginal likelihood function according to the effective atomic number, and FIG. 3C shows the marginal likelihood function according to the thickness.

### DETAILED DISCLOSURE OF PARTICULAR EMBODIMENTS

We shall consider in what follows a material for which it is desired to measure the effective atomic number using X or gamma transmission spectrographic measurements. A direct conversion spectrometry such as mentioned in the introduction can be used for this purpose.

It shall be supposed that the measurement of the atomic number is carried out in a homogeneous zone of the material, either the material is itself homogeneous, or that the X or gamma beam is sufficiently fine so that it can be considered that the irradiated zone is homogeneous. It shall be understood in particular that an object can be swept with a beam in such a way as to take a measurement at each point and as such create a map of the effective atomic number.

The transmission spectrometry measurement, designated hereinafter more simply transmission spectrum, is represented by a vector S^{a}=(n₁^{o}, n₂^{a}, . . . , n_{N}^{a})^{T} where N is the number of energy channels (also referred to as detection channels), with each value nᵢ^{a} representing the number of pulses observed in the channel i during a given measurement time, T. The value nᵢ^{a} is also called the score of the channel i during the measurement time T. The effective atomic number of the material is noted as Z_{eff} or, more simply Z, and its estimation from the spectrometry measurement, is noted as \hat{Z}.

It shall be supposed that a calibration of the measurement of Z has been carried out beforehand using a plurality PQ of samples of different materials p=1, . . . , P and of different thicknesses e₁, . . . , e_{Q}, referred to as calibration samples (or standards). We shall suppose, without losing generality, that for each material p the calibration is carried out for the same plurality Q of thicknesses, in other words that there are, for each calibration material p, Q standards of different thicknesses. The effective atomic number of a sample of material p and of thickness e_{q} is noted as Z_{p,q}^{c}.

The idea at the base of the invention is to adopt an probabilistic approach by carrying out, from a transmission spectrum of a sample, an estimation of the effective atomic number of the material constituting the sample, and where applicable of the thickness of this sample, according to a MAP (Maximum A Posteriori) criterion or according to a an ML (Maximum Likelihood) criterion.

More precisely, the probability that the sample analysed has an effective atomic number Z and a thickness e, in light of the transmission spectrum S^{a} measured, is given by Bayes' theorem:

Pr(θ|S^{a})∝Pr(S^{a}|θ)Pr(θ) (1)

where ∝ is the sign of proportionality (the term Pr(S^{a}) mentioned in the denominator in Bayes' formula can be omitted as it is independent of θ), Pr(x|y) represents the conditional probability of x knowing that y is carried out and where θ=(Z,e) is the pair constituted of the effective atomic number and of the thickness of the material.

The MAP estimation criterion is an optimum criterion aimed at searching the maximum probability a posteriori, i.e.:

$${\hat{θ}}_{MAP} = {arg max}_{θ} ( Pr ( θ \vert {S}^{a} ) ) \qquad ( 2 )$$

If it is supposed that the probability distribution of θ is uniform, in other words if all of the materials and all of the thicknesses of material to be analysed are equiprobable, Pr(θ) is a constant and it is then possible to carry out an estimate in terms of the maximum likelihood criterion, i.e.:

$${\hat{θ}}_{ML} = {arg max}_{θ} ( Pr ( {S}^{a} \vert θ ) ) \qquad ( 3 )$$

For a given transmission spectrum S^{a} (observation), the function V(θ)=Pr(S^{a}|θ) is called a likelihood function θ. The transmission spectrum S^{a} can be considered as a random vector of dimension N configured by θ, in other words the law of probability distribution of S^{a} is configured by θ. V(θ) then represents the likelihood (or abusively the probability) that the parameter of the law of distribution is θ, in light of the realisation S^{a}.

If it is supposed that the components of the random vector S^{a} are independent, in other words that the scores in the various channels of the spectrum are independent random variables, the likelihood function can still be written:

$$V ( θ ) = {\prod }_{i = 1}^{N} Pr ( {n}_{i}^{a} \vert θ ) \qquad ( 4 )$$

If it is further supposed that the material analysed is one of the calibration materials, the likelihood function is simply given by:

$$V ( {Z}^{c} , {e}^{c} ) = {\prod }_{i = 1}^{N} Pr ( {n}_{i}^{a} \vert {n}_{i}^{c} ( {Z}^{c} , {e}^{c} ) ) \qquad ( 5 )$$

where nᵢ^{c}(Z^{c},e,^{c}) designates the score of the channel i in the calibration phase for the sample of effective atomic number Z^{c} and of thickness e^{c}.

According to a first embodiment, a statistical modelling of the rate of transmission of the material in each energy channel is used: when the number N of channels is sufficiently large (spectrum finely discretised) and the measurement time temps T sufficiently long, the rate of transmission in each channel follows a Gaussian distribution. Then note

$${α}_{i} = \frac{{n}_{i}^{a}}{{n}_{0 , i}^{a}}$$

the transmission coefficient of the material in the energy channel i during the measuring, where rtg, is the score of the channel in full flow conditions, i.e. in the absence of the material and for the same irradiating time. Similarly,

$${α}_{i}^{c} = \frac{{n}_{i}^{c}}{{n}_{0 , i}^{c}}$$

denotes the transmission coefficient in the energy channel i of the sample during the calibration phase. The probability Pr(αᵢ) of the transmission coefficient follows the Gaussian distribution:

$$Pr ( {α}_{i} ) ∝ exp \frac{{( {α}_{i} - {α}_{i}^{c} )}^{2}}{2 {σ}^{2}} with {σ}^{2} = {( {α}_{i}^{c} )}^{2} \qquad ( 6 )$$

and consequently the probability of the score nᵢ^{a} is given by:

$$Pr ( {n}_{i}^{a} ) = exp \frac{- {( {μ}_{i} {n}_{i}^{a} - {n}_{i}^{c} )}^{2}}{2 {( {n}_{i}^{c} )}^{2}} with {μ}_{i} = \frac{{n}_{0 , i}^{c}}{{n}_{0 , i}^{a}} \qquad ( 7 )$$

The ratio μᵢ expresses the derivative of the source and detector unit between the calibration instant and the measurement instant. In the absence of a derivative, μᵢ=1. It is deduced from expressions (4) and (7) that:

$$V ( {Z}^{c} , {e}^{c} ) = \frac{1}{{\prod }_{i = 1}^{N} {n}_{i}^{c}} exp [ - {\sum }_{i = 1}^{N} \frac{{( {μ}_{i} {n}_{i}^{a} - {n}_{i}^{c} )}^{2}}{2 {( {n}_{i}^{c} )}^{2}} ] \qquad ( 8 )$$

Equivalently, the likelihood function can also be written from the transmission coefficients in the following form:

$$V ( {Z}^{c} , {e}^{c} ) = \frac{1}{{\prod }_{i = 1}^{N} {α}_{i}^{c} {n}_{0 , i}^{c}} exp [ - {\sum }_{i = 1}^{N} \frac{1}{2} {( \frac{{α}_{i} - {α}_{i}^{c}}{{α}_{i}^{c}} )}^{2} ] \qquad ( {8}^{′} )$$

where it is recalled that the score nᵢ^{c} depends in the effective atomic number and on the thickness of the standard. For this reason, it will also be noted as nᵢ^{c}(Zₚ^{c},e_{q}^{c}). Similarly the transmission coefficient αᵢ^{c} will also be noted as αᵢ^{c}(Zₚ^{c},e_{q}^{c}).

According to the first embodiment of the invention, for each calibration material, the maximum of the likelihood function is determined over the various thicknesses, i.e. the value of the likelihood function:

$${V}_{p} = {max}_{q} ( V ( {Z}_{p}^{c} , {e}_{q}^{c} ) ) \qquad ( 9 )$$

The effective atomic number of the material to be analysed is then estimated by taking an average of the effective atomic numbers of the calibration materials weighted by the respective values of the likelihood function for these materials, i.e.:

$$\hat{Z} = \frac{{\sum }_{p = 1}^{P} {V}_{p} {Z}_{p}^{c}}{{\sum }_{p = 1}^{P} {V}_{p}} \qquad ( 10 )$$

According to an alternative of this first embodiment, first, for each material p an interpolation is carried out, according to the thickness, between the calibration spectra (even, where applicable an extrapolation from the latter) in order to determine an interpolated calibration spectrum for each thickness e∈[eₘᵢₙ,eₘₐₓ] (where [eₘᵢₙ,eₘₐₓ] is a thickness range assumed to be common to all of the calibration samples). The likelihood function V (Zₚ^{c},e) can then be evaluated over a thickness range. This evaluation is obtained by replacing in the expression (8) the scores nᵢ^{c}(Zₚ^{c},e_{q}^{c}) of the calibration spectra with their interpolated values defined by:

$$ln [ {n}_{i}^{c} ( {Z}_{p}^{c} , e ) ] = ( \frac{{e}_{q + 1}^{c} - e}{{e}_{q + 1}^{c} - {e}_{q}^{c}} ) ln [ {n}_{i}^{c} ( {Z}_{p}^{c} , {e}_{q}^{c} ) ] + ( \frac{e - {e}_{q}^{c}}{{e}_{q + 1}^{c} - {e}_{q}^{c}} ) ln [ {n}_{i}^{c} ( {Z}_{p}^{c} , {e}_{q + 1}^{c} ) ] \qquad ( 11 )$$

where e_{q}^{c} and e_{q+1}^{c} are the thicknesses such that e_{q}^{c}<e<e_{q+1}^{c} (it is supposed here that the thicknesses are indexed by increasing values).

In the case of an extrapolation to a thickness that is higher than the highest known thickness, e_{Q}, the expression (11) is again used where, preferably, e_{q+1} corresponds to the highest thickness of the standard. In the case of an extrapolation to a thickness that is lower than the lowest known thickness, e, , the expression (11) is used where, preferably, e_{q} corresponds to the lowest thickness of the standard.

The expression (11) however supposes that the source and detector unit is not derived between the calibration instant and the measuring instant (i.e. μᵢ1, i=1, . . . , N). In the presence of a derivative, the scores of the various channels should be standardised by the full flow scores, i.e.:

$$ln [ \frac{{n}_{i}^{c} ( {Z}_{p}^{c} , e )}{{n}_{0 , i}^{c} ( {Z}_{p}^{c} , e )} ] = ( \frac{{e}_{q + 1}^{c} - e}{{e}_{q + 1}^{c} - {e}_{q}^{c}} ) ln [ \frac{{n}_{i}^{c} ( {Z}_{p}^{c} , {e}_{q}^{c} )}{{n}_{0 , i}^{c} ( {Z}_{p}^{c} , {e}_{q}^{c} )} ] + ( \frac{e - {e}_{q}^{c}}{{e}_{q + 1}^{c} - {e}_{q}^{c}} ) ln [ \frac{{n}_{i}^{c} ( {Z}_{p}^{c} , {e}_{q + 1}^{c} )}{{n}_{0 , i}^{c} ( {Z}_{p}^{c} , {e}_{q + 1}^{c} )} ] \qquad ( 12 )$$

where n_{0,i}^{c}(Zₚ^{c},e_{q}^{c}) and n_{0,i}(Zₚ^{c},e_{q+1}^{c}) are respectively the full flow scores in the channel i during the calibration with the calibration material p for the thicknesses of sample e_{q}^{c} and e_{q+1}^{c}, respectively, and where n_{0,i}^{c}(Zₚ^{c}, e) is the interpolated full flow score:

$${n}_{0 , i}^{c} ( {Z}_{p}^{c} , e ) = \frac{{n}_{0 , i}^{c} ( {Z}_{p}^{c} , {e}_{q + 1}^{c} ) - {n}_{0 , i}^{c} ( {Z}_{p}^{c} , {e}_{q}^{c} )}{{e}_{q + 1}^{c} - {e}_{q}^{c}} e + \frac{{n}_{0 , i}^{c} ( {Z}_{p}^{c} , {e}_{q}^{c} ) {e}_{q + 1}^{c} - {n}_{0 , i}^{c} ( {Z}_{p}^{c} , {e}_{q + 1}^{c} ) {e}_{q}^{c}}{{e}_{q + 1}^{c} - {e}_{q}^{c}} \qquad ( 13 )$$

In any case, once the interpolation/extrapolation of the likelihood function carried out according to the thickness, the value of the marginal likelihood function can be deduced from it:

$${V}_{p}^{′} = {\int }_{{e}_{min}}^{{e}_{max}} ( V ( {Z}_{p}^{c} , e ) ) d e \qquad ( 14 )$$

In the case where the materials (Zₚ^{c},e) are not equiprobable, the marginal likelihood function is then written:

$${V}_{p}^{′} = {\int }_{{e}_{min}}^{{e}_{max}} ( V ( {Z}_{p}^{c} , e ) ) Pr ( {Z}_{p}^{c} , e ) d e \qquad ( 15 )$$

Pr(Zₚ^{c},e) designating the probability a priori of the material p at thickness e.

The effective atomic number of the material analysed is then estimated as an average of the effective atomic numbers of the calibration materials, weighted by the respective values of the marginal likelihood function for these materials, i.e.:

$$\hat{Z} = \frac{{\sum }_{p = 1}^{P} {V}_{p}^{′} {Z}_{p}^{c}}{{\sum }_{p = 1}^{P} {V}_{p}^{′}} \qquad ( 16 )$$

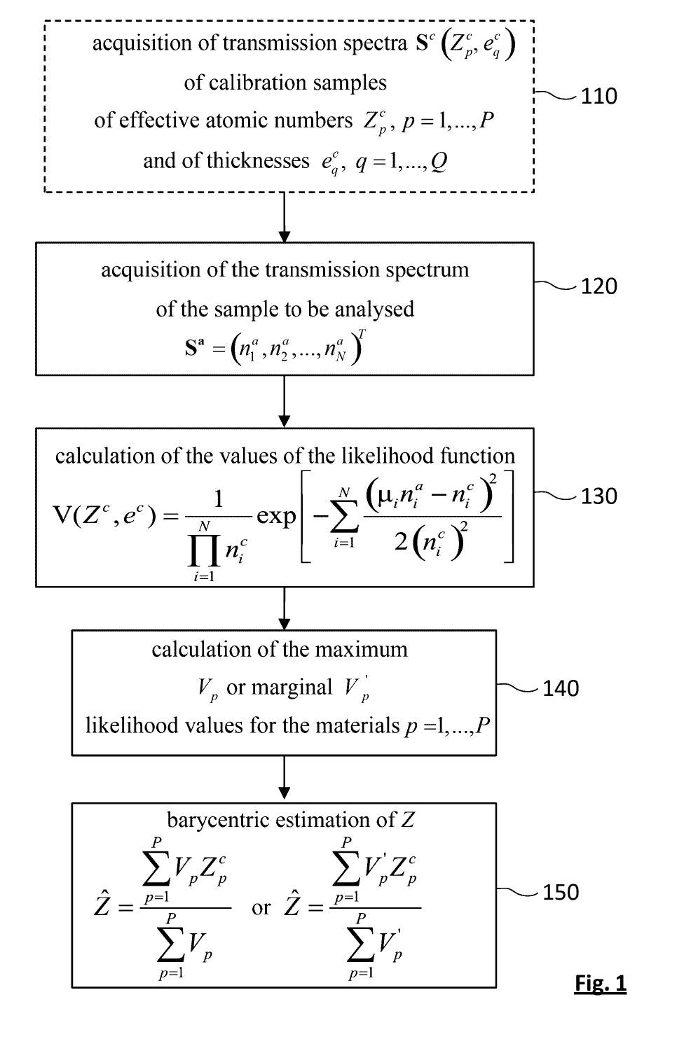

FIG. 1 includes in the form of a flowchart the method for estimating the effective atomic number of a material from its transmission spectrum, according to the first embodiment of the invention.

Prior to the estimating properly speaking, it is assumed that in a step 110, a calibration has been carried out from a plurality PQ of samples of P different calibration materials, each material being represented by Q samples of different thicknesses. The effective atomic numbers Z_{c}^{p}, p=1, . . . , P, of these calibration materials are assumed to be known. They can be for example of the simple bodies for which the effective atomic number corresponds to the atomic number of this body. The transmission spectra obtained for the PQ samples, referred to as calibration spectra, are noted as S^{c}(Zₚ^{c},e_{q}^{c}) or more simply S_{pq}^{c}, p=1, . . . , P, q=1, . . . , Q. Each spectrum S^{c}(Zₚ^{c},e_{q}^{c}) can correspond in practice to the average of a large number (several hundred, even several thousand) calibration acquisitions.

The step of calibration 110 can have been carried out once for all or be repeated regularly and even systematically carried out before any new measurement. It is also understood that this step is optional in the method for estimating. It was shown for this reason in discontinuous lines.

In the step 120, a measurement of the transmission spectrum of the material to be analysed is taken. The transmission spectrum S^{a}=(n₁^{a}, n₂^{a}, . . . , n_{N}^{a})^{T} is is obtained

In the step 130, from the transmission spectrum S^{a}=(n₁^{a}, n₂^{a}, . . . , n_{N}^{a})^{T} and from the PQ calibration spectra, the PO values V (Zₚ^{c},e_{q}^{c}) of the likelihood function are calculated using the expression (8). These values indicate the respective proximity of the spectrum measured with each of one the PQ spectra of the calibration samples.

In the step 140, the maximum likelihood values Vₚ or the marginal likelihood values V′ₚ are calculated for the various calibration materials, according to the alternative considered.

In the step 150, the effective atomic number of the material is estimated as an average of the atomic numbers of the calibration materials weighted by the marginal or maximum likelihood values calculated in the preceding step.

According to a second embodiment of the invention, a statistical modelling of the transmission spectrum of the material to be analysed is used. To do this, the number of photons transmitted by the analysed material is determined by supposing that the arrival of the photons in each energy channel follows a Poisson distribution. More precisely, for each energy channel i, the probability that there is exactly a score of nᵢ^{a} photons transmitted by the material during the irradiation time T, knowing that the material is of effective atomic number Z and of thickness e, is given by:

$$Pr ( {n}_{i}^{a} \vert Z , e ) = {e}^{- {v}_{i}} \frac{{v}_{i}^{{n}_{i}^{a}}}{{n}_{i}^{a} !} \qquad ( 17 )$$

where vᵢ is the average number of photons transmitted by the material (Z,e) in the channel i during the irradiation time T (chosen to be identical for measuring and for calibrating).

As in the first embodiment, PQ transmission spectra S_{pq}^{c} are available corresponding to PQ calibration samples (P materials, Q thicknesses for each material). In the second embodiment, the spectra S_{pq}^{c} are interpolated, and, where applicable, extrapolated in order to obtain a calibration spectrum S^{c}(Z,e)=(n₁^{c}, n₂^{c}, . . . , n_{N}^{c})^{T} for each effective atomic number Z included in an interval [Zₘᵢₙ,Zₘₐₓ] and each thickness e included in an interval [eₘᵢₙ,eₘₐₓ]. The interpolation distributions of the spectra S_{pq}^{c} according to the effective atomic number and the thickness are mentioned further on.

If it is supposed that the sample to be analysed has an effective atomic number Z and a thickness e, the average number of photons transmitted by the material, vᵢ^{a}, during the irradiation time can be linked to the score nᵢ^{c} of the calibration spectrum S^{c}(Z,e) (non-noisy) in the same channel, par:

$${v}_{i}^{a} = μ {n}_{i}^{c} with μ = \frac{{\overline{n}}_{0}^{a}}{{\overline{n}}_{0}^{c}} \qquad ( 18 )$$

where

$${\overline{n}}_{0}^{c} = {\sum }_{i = 1}^{N} {n}_{0 , i}^{c} and {\overline{n}}_{0}^{a} = {\sum }_{i = 1}^{N} {n}_{0 , i}^{a}$$

are respectively the total number of photons in the full flow spectrum (i.e. in the absence of material), during calibration and during measurement. The ratio translates the offset of the spectrometer between the calibration phase and the measuring phase. This offset can be due to the source and/or to the detector. In the absence of a derivative, μ=1.

The natural logarithm of the likelihood function given by (5) is expressed as follows:

$$ln ( V ( Z , e ) ) = {\sum }_{i = 1}^{N} ln [ Pr ( {n}_{i}^{a} \vert {n}_{i}^{c} ( Z , e ) ) ] \qquad ( 19 )$$

and, by taking into account (17) and (18):

$$\begin{matrix}ln ( V ( Z , e ) ) = - {\sum }_{i = 1}^{N} {v}_{i} + {\sum }_{i = 1}^{N} {n}_{i}^{a} ln {v}_{i} - {\sum }_{i = 1}^{N} {n}_{i}^{a} ! \\ = - μ {\overline{n}}^{c} + {\sum }_{i = 1}^{N} {n}_{i}^{a} ln ( μ {n}_{i}^{c} ) - {\sum }_{i = 1}^{N} {n}_{i}^{a} !\end{matrix} \qquad ( 20 )$$

with

$${\overline{n}}^{c} = {\sum }_{i = 1}^{N} {n}_{i}^{c}$$

the total number of photons transmitted over all of the channels during the calibration phase.

The effective atomic number is searched and, where applicable, the thickness that maximises V (Z,e), or equivalently ln(V(Z,e)). In other terms, the pair (Z,e) that leads to the probability distribution of S^{c}(Z,e) that is as close as possible to S^{a} is generally sought. As the last term of (16),

$${\sum }_{i = 1}^{N} {n}_{i}^{a} ! ,$$

depends only on the transmission spectrum of the analysed sample, S^{a}, it can be ignored in the expression of ln(V(Z, e)) which is then reduced to:

$$ln ( V ( Z , e ) ) = - μ {\overline{n}}^{c} + {\sum }_{i = 1}^{N} {n}_{i}^{a} ln ( μ {n}_{i}^{c} ) \qquad ( 21 )$$

Definitively, the effective atomic number and, where applicable, the thickness of the analysed material can be estimated by:

$$( {\hat{Z}}_{ML} , {\hat{e}}_{ML} ) = {argmax}_{Z ∈ {[ Z min , Z max ]}_{e ∈ [ e min , e max ]}} [ - μ {\overline{m}}^{c} ( Z , e ) + {\sum }_{i = 1}^{N} {n}_{i}^{a} ln ( μ {n}_{i}^{c} ( Z , e ) ) ] \qquad ( 22 )$$

with the search for the maximum being carried out on all of the pairs (Z , e) of the range [Zₘᵢₙ,Z ₘₐₓ][eₘᵢₙ,eₘₐₓ]. In practice, those skilled in the art can implement known search algorithms.

As the thickness is not necessarily a parameter of interest for the analysis of the material, the search can be restricted to a single parameter Z by using the marginal density of the likelihood function:

$$p ( Z ) = \frac{{\int }_{{e}_{min}}^{{e}_{max}} V ( Z , e ) d e}{{\int }_{{Z}_{min}}^{{Z}_{max}} {\int }_{{e}_{min}}^{{e}_{max}} V ( Z , e ) d Z . d e} \qquad ( 23 )$$

where the likelihood function V (Z, e) is given by (21).

According to a first alternative of the second embodiment, the effective atomic number of the analysed material is estimated by the value corresponding to the maximum of the marginal density:

$${\hat{Z}}_{marg} = {argmax}_{Z} ( p ( Z ) ) \qquad ( 24 )$$

Alternatively, according to a second alternative, the effective atomic number of the analysed material can be estimated from the expectation of Z, i.e. the average of Z weighted by the marginal density:

\hat{Z}=∫_{Z}_{ₘᵢₙ}^{Z}^{ₘₐₓ}Zp(Z)dZ (25)

Other estimations using the likelihood function V(Z ,e) or its marginal density p(Z) can be considered by those skilled in the art without however leaving the scope of this invention.

As mentioned hereinabove, the second embodiment requires carrying out an interpolation (even, where applicable, an extrapolation) of the likelihood function (or of its logarithm) regarding the effective atomic numbers as well as the thicknesses. At the end of the calibration there are PQ calibration spectra S_{pq}^{c} available and therefore, for each calibration sample p,q of the scores nᵢ^{c}(Zₚ^{c},e_{q}^{c}), i=1, . . . , N. The interpolation of the calibration spectra on a range of thicknesses [eₘᵢₙ,eₘₐₓ] is obtained by means of the expression (11) in the absence of an offset of the spectrometer (source and detector) and by means of the expression (13) if the spectrometer is affected by an offset. Likewise, if the spectra have to be extrapolated below the value e₁^{c} or beyond the value e_{Q}^{c}, the expressions (12) and (14) are respectively used in the absence and in the presence of the offset.

In any case, for a given material p, and for any thickness e∈[eₘᵢₙ, eₘₐₓ], an interpolated calibration spectrum defined by nᵢ^{c}(Zₚ^{c};e) i =1, . . . , N is as such obtained. By using the scores interpolated as such in the equation (21), the likelihood function can be calculated regardless of the thickness e∈[eₘᵢₙ, eₘₐₓ], i.e.

$$ln ( V ( {Z}_{p}^{c} , e ) ) = - μ {\overline{n}}^{c} + {\sum }_{i = 1}^{N} {n}_{i}^{a} ln ( μ {n}_{i}^{c} ( {Z}_{p}^{c} , e ) ) .$$

Similarly, the interpolation (even, where applicable, an extrapolation) is carried out on the calibration spectra over a range of effective atomic numbers Z∈[Zₘᵢₙ,Zₘₐₓ]. To do this, calibration spectra already interpolated in thickness are used, and therefore scores nᵢ^{c}(Zₚ^{c}, e), i=1, . . . , N; p=1, . . . , P.

The dependency of nᵢ^{c}(Z,e) according to the effective atomic number Z is modelled by the following distribution:

nᵢ^{c}(Z,e)=n_{0,i}^{c} exp(−ρ(αZ^{r}+β)) (26)

n_{0,i}^{c} is the score of the full flow spectrum in the channel i during the measurement of the transmission spectrum for the sample of effective atomic number Z and of thickness e, or encore, in logarithmic form:

ln[nᵢ^{c}(Z,e)]=ln[n_{0,i}^{c}]−ρ(αZ^{r}+β) (26′)

where α, β,r are constants and p is the density of the material.

This modelling is based on the fact that the effective cross-section of interaction of the photons with the atoms of the material is broken down into a photoelectric effective cross-section that depends on Z (where the exponent r≈4.62, this value can be optimised experimentally) and into a Compton effective cross-section that does not depend on this (constant β).

The interpolated value nᵢ^{c}(Z,e) between two consecutive effective atomic numbers of calibration materials, i.e. for Zₚ^{c}<Z<Zₚ₊₁^{c}, is then given by:

$$ln [ {n}_{i}^{c} ( Z , e ) ] = ( 1 - {γ}_{p}^{1} \frac{ρ}{{ρ}_{p}} - {γ}_{p}^{2} \frac{ρ}{{ρ}_{p + 1}} ) ln [ {n}_{0 , i}^{c} ] + ( {γ}_{p}^{1} \frac{ρ}{{ρ}_{p}} ) ln [ {n}_{i}^{c} ( {Z}_{p}^{c} , e ) ] + ( {γ}_{p}^{2} \frac{ρ}{{ρ}_{p + 1}} ) ln [ {n}_{i}^{c} ( {Z}_{p + 1}^{c} , e ) ] \qquad ( 27 )$$

and where ρₚ, ρₚ₊₁ are respectively the densities of the materials p and p+1. A similar expression can be used in the case of an extrapolation.

The relation (27) suppose however that the source and detector unit does not have any offset between the calibration instant and the measurement instant (i.e. μᵢ=1, i=1, . . . , N In the presence of an offset, it is suitable to standardise the scores of the different channels by the full flow scores, i.e.:

$$ln [ \frac{{n}_{i}^{c} ( Z , e )}{{n}_{0 , i}^{c} ( Z , e )} ] = ( {γ}_{p}^{1} \frac{ρ}{{ρ}_{p}} ) ln [ \frac{{n}_{i}^{c} ( {Z}_{p}^{c} , e )}{{n}_{0 , i}^{c} ( {Z}_{p}^{c} , e )} ] + ( {γ}_{p}^{2} \frac{ρ}{{ρ}_{p + 1}} ) ln [ \frac{{n}_{i}^{c} ( {Z}_{p + 1}^{c} , e )}{{n}_{0 , i}^{c} ( {Z}_{p + 1}^{c} , e )} ] \qquad ( 28 )$$

where n_{0,i}^{c}(Zₚ^{c}, e) and n_{0,i}^{c}(Zₚ₊₁^{c}, e) are the full flow scores in the channel i, relative to the calibration spectra interpolated at the thickness e, for the respective calibration materials of effective atomic numbers Zₚ^{c} and Zₚ₊₁^{c}, and where n_{0,i}^{c}(Zₚ^{c}, e) is the full flow score for this same channel, interpolated at the effective atomic number Z, defined by:

$${n}_{0 , i}^{c} ( Z , e ) = \frac{{n}_{0 , i}^{c} ( {Z}_{p + 1}^{c} , e ) - {n}_{0 , i}^{c} ( {Z}_{p}^{c} , e )}{{Z}_{p + 1}^{c} - {Z}_{p}^{c}} Z + \frac{{n}_{0 , i}^{c} ( {Z}_{p + 1}^{c} , e ) {Z}_{p}^{c} - {n}_{0 , i}^{c} ( {Z}_{p}^{c} , e ) {Z}_{p + 1}^{c}}{{Z}_{p + 1}^{c} - {Z}_{p}^{c}} \qquad ( 29 )$$

The density of the material varies slightly with the effective atomic number Z. This variation distribution can for example be approximated by a linear distribution, in other words:

$$ρ = \frac{{ρ}_{p + 1} - {ρ}_{p}}{{Z}_{p + 1}^{c} - {Z}_{p}^{c}} Z + \frac{{ρ}_{p + 1} {Z}_{p}^{c} - {ρ}_{p} {Z}_{p + 1}^{c}}{{Z}_{p + 1}^{c} - {Z}_{p}^{c}} \qquad ( 30 )$$

The interpolation of the calibration spectra on the range [Zₘᵢₙ, Zₘₐₓ]×[eₘᵢₙ,eₘₐₓ] was carried out hereinabove by means of an interpolation on the thicknesses followed by a second interpolation on the effective atomic numbers. Other interpolation formulas, that those skilled in the art will understand as well as the calibration spectra could alternatively have been subjected to an interpolation on the effective atomic numbers followed by an interpolation on the thicknesses.

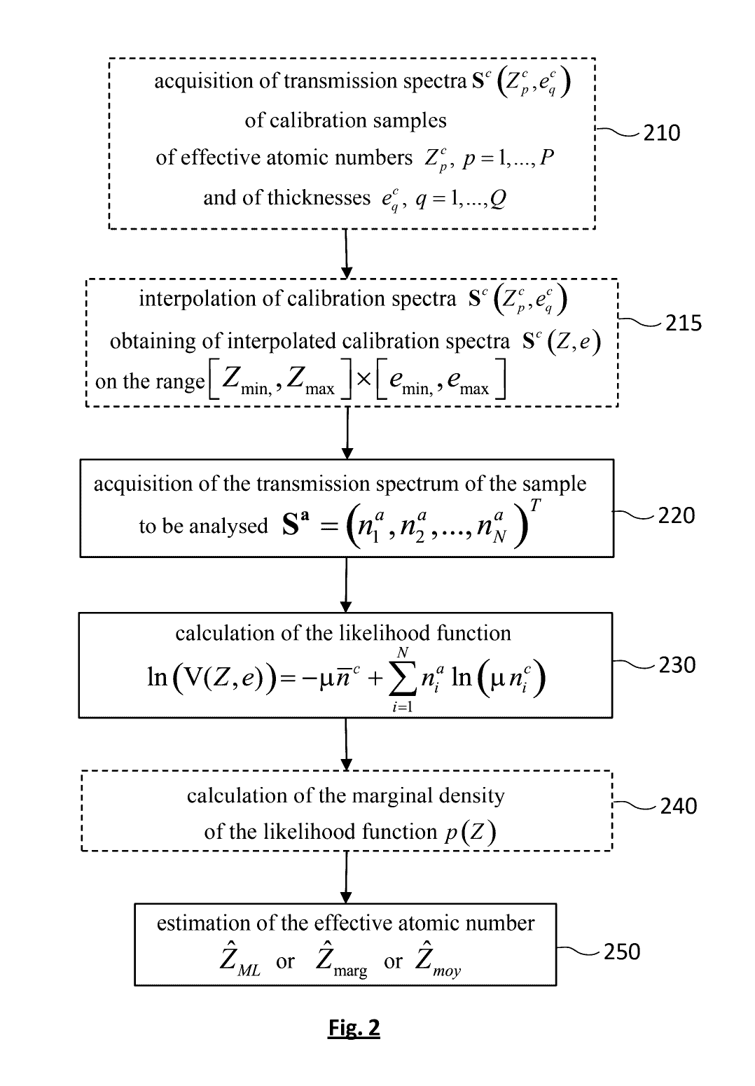

FIG. 2 includes in the form of a flowchart the method for estimating the effective atomic number of a material from its transmission spectrum, according to the second embodiment of the invention.

As in the first embodiment, a calibration is carried out beforehand in 210 from a plurality PQ of samples of P different materials, each material being represented by Q samples of different thicknesses. The effective atomic numbers Z_{c}^{p}, p=1, . . . , P, of these calibration materials are assumed to be known. At the end of this step a plurality PQ of transmission spectra S_{pq}^{c} are available respectively obtained for the PO standards. This step is optional in that it is not necessarily repeated at each measurement and can have been carried out once and for all before a measurement campaign.

In the step 215, the transmission spectra S_{pq}^{c} are interpolated in order to obtain calibration spectra S^{c}(Z,e) for each value of Z∈[Zₘᵢₙ,Zₘₐₓ] and each value of e∈[eₘᵢₙ,eₘₐₓ]. In practice, these interpolations are carried out for a large number of discrete values (much higher than PQ) corresponding to a fine sampling of the intervals [Zₘᵢₙ,Zₘₐₓ] and [eₘᵢₙ,eₘₐₓ]. This step, such as the preceding step, can be carried out once and for all, prior to the measurements.

In the step 220, a measurement is taken of the transmission spectrum of the material to be analysed in a plurality N of energy channels, i.e. S^{a}=(n₁^{c}, n₂^{c}, . . . , n_{N}^{a})^{T}.

In the step 230, from the transmission spectrum S^{a}=(n₁^{a}, n₂^{a}, . . . , n_{N}^{a})^{T} and from the calibration spectra S^{c}(Z,e) for Z∈[Zₘᵢₙ,Zₘₐₓ] and e∈[eₘᵢₙ,eₘₐₓ], the likelihood function, or its logarithm given by the expression (21) is calculated.

Optionally, in step 240, the marginal density of the likelihood function is calculated using the expression (23).

In the step 240, the effective atomic number of the material to be analysed is estimated as the one that maximises the likelihood function (cf. expression (22)) or its marginal density in relation to Z (cf. expression (23)), even as the average of the effective atomic number on [Zₘᵢₙ, Zₘₐₓ] weighted by said marginal density (cf. expression (25)).

The method for estimating according to the invention was evaluated using a simulation. The simulated spectrometer is a detector with a CdTe base comprised of pixels of 800×800 μm² and 3 mm thick. The induction effect linked to the propagation of the charges in the detector as well as the sharing effect of the charge with the adjacent pixels was taken into account, as well as the degradation of the resolution of the response of the detector with the intensity of the flow. A spectrum of 20,000 incident photons between 15 keV and 120 keV was simulated. The number of energy channels considered was N=105 (steps of 1 keV).

The calibration materials were made of Polyethylene (PE), Polyoxymethylene (POM) or Delrin™, Polyvinylidene fluoride (PVDF) or Kynar™. The samples of these materials were of thicknesses ranging from 0.5 cm to 20 cm in steps of 0.5 cm. In other words in this case P=3 and Q=40 . The effective atomic numbers of the calibration materials were taken respectively at Z(PE)=5.80; Z(POM)=7.26; Z(PVDF)=8.20 .

The sample to be analysed was made of Polytetrafluoroethylene (PTFE) or Teflon™ (effective atomic number Z(PTFE)=8.56) and of thickness 4.5 cm.

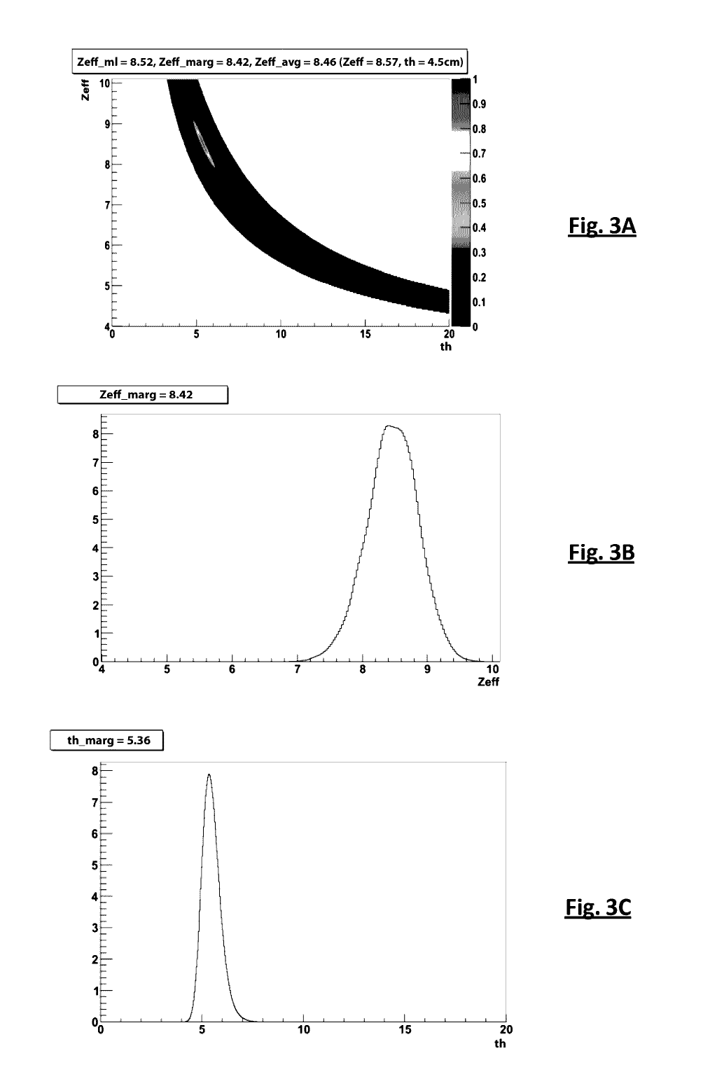

FIG. 3A shows the likelihood function V(Z,e) of a noisy realisation of a transmission spectrum of 5.5 cm of PTFE. The step of discretisation in effective atomic number Z was 0.025 and the one in thickness e was 0.025 cm.

FIG. 3B shows the likelihood function marginal density (or marginal likelihood function) according to the atomic number such as defined in the expression (23). Note that this function has a peak for \hat{Z}_{marg}=8.42 (estimator defined by the expression (24)).

The estimation according to the maximum of likelihood (estimator defined by the given expression (22)) \hat{Z}_{ML}=8.52 and that according to the average weighted by the marginal density (estimator defined by the given expression (25)) \hat{Z}_{moy}=8.46. It can be seen that in this case, the estimator \hat{Z}_{ML} is the closest to the real value (Z(PTFE)=8.56).

FIG. 3C shows the marginal density of the likelihood function according to the thickness. It can be seen that the latter has a peak at 5.2 cm, with therefore here an prediction error of 0.7 cm.

These estimations can be then improved by taking into consideration a larger number of calibration materials and by using a finer discretisation as effective atomic number and as thickness.

1-17. (canceled)

18. A method for measuring the effective atomic number of a material for a predetermined X or gamma spectral band, comprising:
a transmission spectrum (S^{a}=(n₁^{a}, n₂^{a}, . . . , n_{N}^{a})^{T}) of a sample of said material in a plurality (N) of energy channels of said spectral band is measured (120, 220);
a likelihood function of the effective atomic number and of the thickness of the sample of said material is calculated (130, 230) from the transmission spectrum measured as such and from a plurality of transmission spectra (S^{c}(Zₚ^{c},e_{q}^{c}), referred to as calibration spectra, obtained for a plurality of samples of calibration materials having known effective atomic numbers and known thicknesses,
the calibration spectra are interpolated in order to obtain an interpolated calibration spectrum for each effective atomic number belonging to a first interval ([Zₘᵢₙ, Zₘₐₓ]), and for each effective atomic number belonging to this interval and each given thickness, a value of said likelihood function is calculated;
the effective atomic number (\hat{Z}) of said material is estimated (140, 240) on the basis of values of the likelihood function thus obtained.

19. The method for measuring the effective atomic number of a material according to claim 18, wherein the calibration spectra are interpolated in order to obtain an interpolated calibration spectrum for each effective atomic number belonging to a second interval ([eₘᵢₙ,eₘₐₓ]) and that for each thickness belonging to this interval and each given effective atomic number, a value of said likelihood function is calculated.

20. The method for measuring the effective atomic number of a material according to claim 19, wherein for each calibration material (p) of known effective atomic number (Zₚ^{c}), an interpolation is carried out between the calibration spectra relative to known thicknesses in order to determine an interpolated calibration spectrum for each thickness of a given thickness interval ([eₘᵢₙ,eₘₐₓ]), with the likelihood function being evaluated over this thickness interval from the interpolated calibration spectrum, and the maximum value of the likelihood function is determined over said thickness interval, said maximum value being associated with the material.

21. The method for measuring the effective atomic number of a material according to claim 20, wherein the effective atomic number (\hat{Z}) of the material is estimated as the average of the effective atomic numbers belonging to a first interval ([Zₘᵢₙ, Zₘₐₓ]), weighted by the maximum values of the likelihood function that are respectively associated to them.

22. The method for measuring the effective atomic number of a material according to claim 19, wherein for each calibration material (p) of known effective atomic number (Zₚ^{c}), an interpolation is carried out between the calibration spectra relative to known thicknesses in order to determine an interpolated calibration spectrum for each thickness of a given thickness interval ([eₘᵢₙ, eₘₐₓ]), with the likelihood function being evaluated over this thickness interval from the interpolated calibration spectrum, then integrated over this thickness interval in order to give a marginal likelihood function value associated with this calibration material.

23. The method for measuring the effective atomic number of a material according to claim 22, wherein the effective atomic number (\hat{Z}) of the material is estimated as the average of the known effective atomic numbers of the calibration materials, weighted by the values of the marginal likelihood function respectively associated with these calibration materials.

24. The method for measuring the effective atomic number of a material according to claim 18, wherein the values of the likelihood function are determined for each pair (Zₚ^{c}, e_{q}^{c}) of effective atomic number and of thickness by:
$$V ( {Z}_{p}^{c} , {e}_{q}^{c} ) = \frac{1}{{\prod }_{i = 1}^{N} {n}_{i}^{c}} exp [ - {\sum }_{i = 1}^{N} \frac{{( {μ}_{i} {n}_{i}^{a} - {n}_{i}^{c} )}^{2}}{2 {( {n}_{i}^{c} )}^{2}} ]$$
where the nᵢ^{a}, i=1, . . . , N are the values of the transmission spectrum of the material in the various channels, nᵢ^{c}, i=1, . . . , N are the values of the transmission spectrum of the calibration material in these same channels and μᵢ is the ratio between the number of photons received in the channel i in the absence of material during the calibration (n_{0,i}^{c}) and the number of photons received in the absence of material during the measuring (n_{0,i}^{a}) in the same channel.

25. The method for measuring the effective atomic number of a material according to claim 18, wherein for each pair (Z ,e) of effective atomic number belonging to a first interval and of thickness belonging to a second interval, the likelihood function V(Z, e) is calculated using:
$$ln ( V ( Z , e ) ) = - μ {\overline{n}}^{c} + {\sum }_{i = 1}^{N} {n}_{i}^{a} ln ( μ {n}_{i}^{c} )$$
where the nᵢ^{a}, i=1, . . . , N are the values of the transmission spectrum of the material in the various channels, nᵢ^{c}, i=1, . . . , N are the values of the interpolated transmission spectrum in these same channels, μ is the ratio between the total number of photons received in all of the channels and in the absence of material during the measuring and the total number of photons received in the same set of channels and in the absence of material during the calibration, and n̅_{c} is the total number of photons received in the same set of channels in the presence of the calibration material, during the calibration.

26. The method for measuring the effective atomic number of a material according to claim 25, wherein the atomic number of the material is estimated as the one (\hat{Z}_{ML}) that maximises the likelihood function V(Z, e) on the range constituted by the Cartesian product between the first interval and the second interval.

27. The method for measuring the effective atomic number of a material according to claim 25, wherein the marginal density (p(Z)) of the likelihood function over said first interval is determined, by integrating the density of the likelihood function over the second interval.

28. The method for measuring the effective atomic number of a material according to claim 26, wherein the effective atomic number of the material is estimated as the one (\hat{Z}_{marg}) that maximises the marginal density over said first interval.

29. The method for measuring the effective atomic number of a material according to claim 26, wherein the effective atomic number of the material is estimated as the average of the effective number (Z_{moy}) weighted by the marginal density of the likelihood function over said first interval.

30. The method for measuring the effective atomic number of a material according to claim 18, wherein for a thickness e between a first known thickness e_{q}^{c} and a second known thickness e_{q+1}^{c} where e_{q}^{c}<e<e_{q+1}^{c}, an interpolated calibration spectrum S^{c}(Z^{c}, e) is obtained for the effective atomic number Z^{c} and the thickness e from the calibration spectra S^{c}(Z′ ,e_{q}^{c}) and S^{c}(Z^{c},e,_{q+1}^{c}) respectively obtained for the same effective atomic number and the respective thicknesses e_{q}^{c} and e_{q-1}^{c}, by means of:
$$ln [ {n}_{i}^{c} ( {Z}^{c} , e ) ] = ( \frac{{e}_{q + 1}^{c} - e}{{e}_{q + 1}^{c} - {e}_{q}^{c}} ) ln [ {n}_{i}^{c} ( {Z}^{c} , {e}_{q}^{c} ) ] + ( \frac{e - {e}_{q}^{c}}{{e}_{q + 1}^{c} - {e}_{q}^{c}} ) ln [ {n}_{i}^{c} ( {Z}^{c} , {e}_{q + 1}^{c} ) ]$$
where nᵢ^{c}(Z^{c},e), nᵢ^{c}(Z^{c},e_{q}^{c}) and nᵢ^{c}(Z^{c},e_{q+1}^{c}) are the respective values of the spectra S^{c}(Z^{c},e),S^{c}(Z^{c},e_{q}^{c}) and S^{c}(Z^{c},e_{q+1}^{c}) in the channel i of the spectral band.

31. The method for measuring the effective atomic number of a material according to claim 17, wherein for an effective atomic number Z between a first known effective atomic number Zₚ^{c} and a second known effective atomic number Zₚ₊₁^{c} where Zₚ^{c}<Z<Zₚ₊₁^{c}, an interpolated calibration spectrum S^{c}(Z,e^{c}) is obtained for the effective atomic number Z and the thickness e′ from the calibration spectra S^{c}(Zₚ^{c},e^{c}) and S^{c}(Zₚ₊₁^{c}, e^{c}) respectively obtained for the same thickness e^{c} and the respective atomic numbers Z ₚ^{c} and Zₚ₊₁^{c}, by means of:
$$ln [ {n}_{i}^{c} ( Z , {e}^{c} ) ] = ( 1 - {γ}_{p}^{1} \frac{ρ}{{ρ}_{p}} - {γ}_{p}^{2} \frac{ρ}{{ρ}_{p + 1}} ) ln [ {n}_{0 , i}^{c} ] + ( {γ}_{p}^{1} \frac{ρ}{{ρ}_{p}} ) ln [ {n}_{i}^{c} ( {Z}_{p}^{c} , {e}^{c} ) ] + ( {γ}_{p}^{2} \frac{ρ}{{ρ}_{p + 1}} ) ln [ {n}_{i}^{c} ( {Z}_{p + 1}^{c} , {e}^{c} ) ]$$
where nᵢ^{c}(Z,e^{c}), nᵢ^{c}(Zₚ^{c},e^{c}), nᵢ^{c}(Zₚ₊₁^{c},e^{c}) are the respective values of the spectra S^{c}(Z, e^{c}), S^{c}(Zₚ^{c},e^{c}) and S^{c}(Zₚ₊₁^{c}, e^{c}) in the channel i of the spectral band, n_{0,i}^{c} is the score of the full flow spectrum in the channel i ,
$${γ}_{p}^{1} = \frac{{( {Z}_{p + 1}^{c} )}^{r} - {Z}^{r}}{{( {Z}_{p + 1}^{c} )}^{r} - {( {Z}_{p}^{c} )}^{r}} , {γ}_{p}^{2} = \frac{{Z}^{r} - {( {Z}_{p}^{c} )}^{r}}{{( {Z}_{p + 1}^{c} )}^{r} - {( {Z}_{p}^{c} )}^{r}} ,$$
is a predetermined real constant, ρₚ,ρₚ₊₁ are respectively the densities of the materials p and p+1, and where ρ is the density of the material of atomic number Z obtained by interpolation between the densities ρₚ and ρₚ₊₁.
